(19) United States
(12) Patent Application Publication
(10) Pub. No.: US 2012/0186735 A1
(43) Pub. Date: Jul. 26, 2012

(54) DEVICE AND METHOD FOR APPLYING DECORATIVE ELEMENTS

(75) Inventor: Ellen Hassman, Hollywood, FL (US)

(73) Assignee: CONSUMER MOTIVATION GROUP, INC., New York, NY (US)

(21) Appl. No.: 13/198,021

(22) Filed: Aug. 4, 2011

Related U.S. Application Data
(60) Provisional application No. 61/461,758, filed on Jan. 24, 2011.

(51) Int. Cl. B44C 1/17; B32B 3/22

(52) U.S. Cl. 156/230; 428/202

(57) ABSTRACT

A device and method for applying a prearranged pattern (e.g. words, numbers, designs, etc.) of individual decorative elements, such as faceted glass crystals, faceted plastic crystals or rhinestones in unison, with a single application, using a pressure sensitive adhesive to thereby provide for an easy single application of the entire prearranged pattern. The prearranged patterns of decorative elements are sandwiched in between a clear acetate top layer and a coated paper bottom layer. To apply the prearranged pattern to a surface, the coated paper bottom layer is removed, leaving the individual decorative elements attached to the clear acetate top layer, before pressing the top layer against the surface. After pressing the prearranged pattern against the surface, the clear acetate top layer is removed, leaving the prearranged pattern of individual decorative elements firmly attached to the surface.

### FIELD OF THE INVENTION

The present invention relates to decorative elements and, more particularly, to a device and method for applying a prearranged pattern of individual decorative elements to the surface of an object.

### DISCUSSION OF THE RELATED ART

Decorative decals, i.e. stickers, are commonly placed on objects for a variety of purposes, including both personal and commercial. A typical sticker consists of a piece of paper or plastic having an adhesive on one side and a decorative element and/or message on the opposite side. Children often put stickers on their lunch boxes while adults often put bumper stickers on their automobile. As related to commercial use, brand stickers are often placed on products to identify the origin of the product.

While the above described type of sticker is widely used, a common problem associated with adhering a more detailed decorative design or message, such as one composed of faceted glass crystals or rhinestones, is the unsightly appearance of each character of the message being displayed on a single sticker, which can result in a considerable amount of space being unnecessarily taken up by the sticker. To combat this issue, a number of decorative decal kits have been provided which include a number of individual decorative character stickers that the user may selectively couple to form a message or design. This can be a considerably tedious process, however, requiring the user to individually apply and line up each of the decorative characters to form the message.

While the devices and methods of application described above are useful for their intended purpose, there remains a need for a more practical and effective device and method for applying decorative elements, such as faceted glass crystals and rhinestones. The present invention seeks to address the limitations and shortcomings of the presently known devices and methods for applying decorative elements.

### OBJECTS AND ADVANTAGES OF THE INVENTION

Considering the foregoing, it is a primary object of the present invention to provide a device for applying a prearranged pattern of decorative elements that can easily be transferred to a smooth surface.

It is a further object of the present invention to provide a device for applying a prearranged pattern of decorative elements requiring only a single application to display the entire message or design.

It is a further object of the present invention to provide a device for applying a prearranged pattern of decorative elements, wherein the decorative elements are faceted glass or plastic crystals.

It is still a further object of the present invention to provide a method of applying a prearranged pattern of decorative elements in a single application.

These and other objects and advantages of the present invention are more readily apparent with reference to the detailed description and accompanying drawings.

### SUMMARY OF THE INVENTION

The present invention is directed to a device and method for applying a prearranged pattern (e.g. words, numbers, designs, etc.) of individual decorative elements, such as faceted glass crystals, faceted plastic crystals or rhinestones in unison, with a single application, using a pressure sensitive adhesive to thereby provide for an easy single application of the entire prearranged pattern. The prearranged patterns of decorative elements are sandwiched in between a clear acetate top layer and a coated paper bottom layer. To apply the prearranged pattern to a surface, the coated paper bottom layer is removed, leaving the individual decorative elements attached to the clear acetate top layer, before pressing the top layer against the surface. After pressing the prearranged pattern against the surface, the clear acetate top layer is removed, leaving the prearranged pattern of individual decorative elements firmly attached to the surface.

### DESCRIPTION OF THE DRAWINGS

For a fuller understanding of the nature of the present invention, reference should be made to the following detailed description taken in conjunction with the accompanying drawings in which:

FIG. 1 is a top view illustrating the device for applying a prearranged pattern of decorative elements of the present invention, shown in accordance with a preferred embodiment;

FIG. 2 is a close up side view illustrating schematically a prearranged pattern of faceted crystals;

FIG. 3 is a perspective view of a prearranged pattern of decorative elements applied to the outer surface of a glass bottle, in accordance with a preferred embodiment; and

FIGS. 4-6 present perspective views of the method of applying the prearranged pattern of decorative elements of FIGS. 1-3 and illustrate a sequence of operation wherein the person applying the prearranged pattern of decorative elements removes the back cover by maintaining a tight curl in the back cover, then applying the front cover to the surface of an object such that the message is properly displayed, and then removing the front cover by maintaining a tight curl in the front cover.

### DETAILED DESCRIPTION OF THE INVENTION

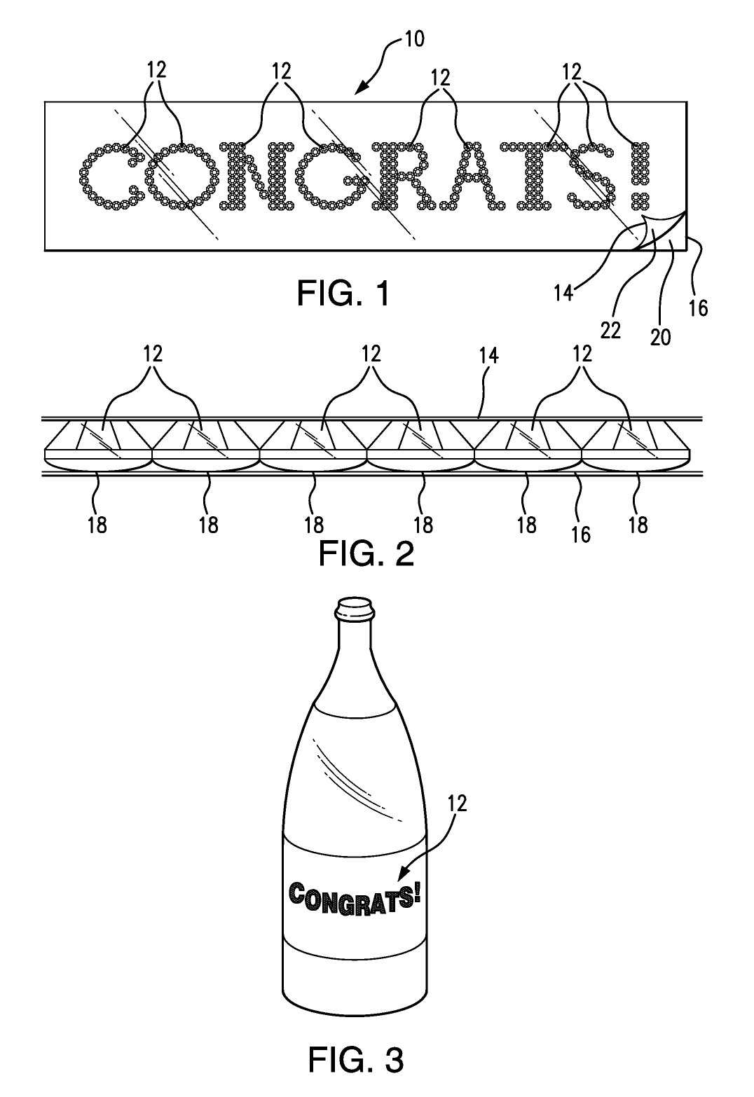

Referring to the several views of the drawings, and initially FIGS. 1 and 2, the device for applying a prearranged pattern of decorative elements of the present invention is shown in accordance to the several embodiments of the invention and is generally indicated as 10.

In each of the embodiments of the invention, the device 10 includes a prearranged pattern of decorative elements 12, which are sandwiched between a top layer 14 and a bottom layer 16, as illustrated in FIG. 2. Each individual decorative element 12 has a bonding agent 18 on the bottom side of the decorative element 12. The inner facing side of the bottom layer 16 has a polished coating 20 that prevents the bonding agent 18 from permanently adhering to the bottom layer 16 prior to application decorative elements 12. The top layer 14 is composed of a clear acetate film 22 having self adhesive characteristics on its inner facing side, thereby maintaining a secure bond between the top layer 14 and the decorative elements 12 prior to application.

A number of different embodiments of the decorative elements 12 have been considered, including, but not limited to, faceted glass crystals, faceted plastic crystals, and rhinestones.

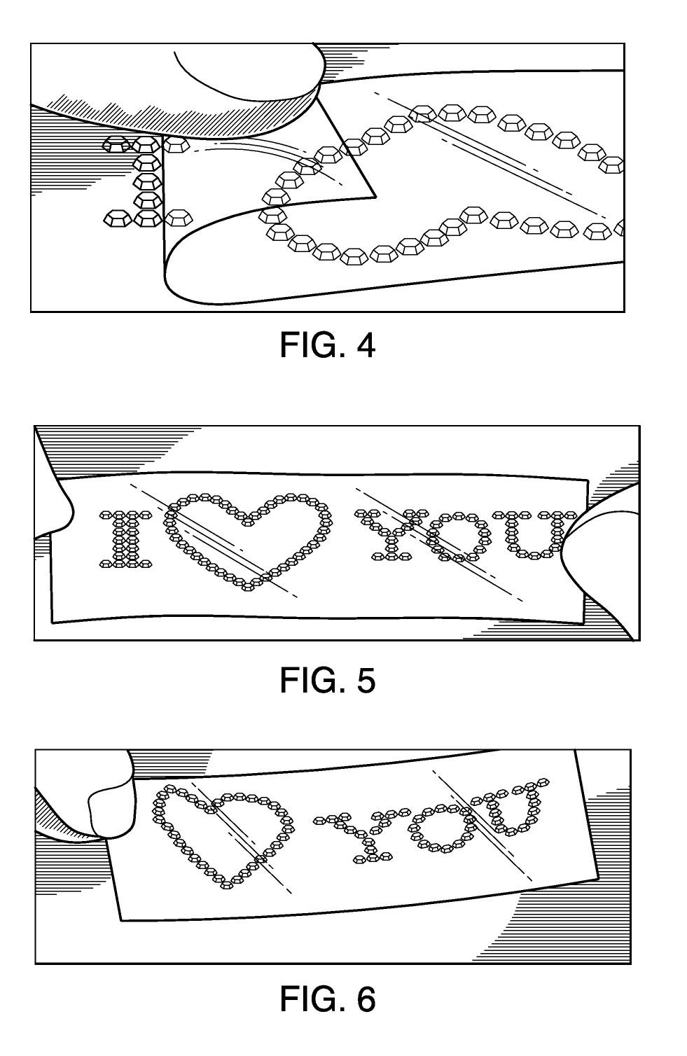

In order to apply a prearranged pattern of decorative elements 12, as illustrated in FIGS. 4-6, the user turns the sheet over backwards and slowly peels the bottom layer 16 away from the top layer 14 while maintaining the bottom layer in a tight curl to ensure that the decorative elements 12 remain on the top layer 14. After the bottom layer 16 has been completely removed, with the decorative elements 12 maintaining a secure bond to the top layer's inner facing side, the top layer 14 is firmly applied to the surface of an object such that the decorative elements 12 are located on the object as desired. The prearranged pattern of decorative elements 12 may be applied to many different objects having a smooth surface, which may often depend on the nature of the message or design, such as a glass bottle, as illustrated in FIG. 3.

As illustrated in FIG. 6, after the top layer 14 has been firmly applied to the surface of an object, the top layer 14 may be peeled off while maintaining the top layer 14 in a tight curl, as previously performed in removing the bottom layer 16. By maintaining the top layer 14 in a tight curl, the prearranged pattern of decorative elements 12 remain adhered to the surface of the selected object.

While the present invention has been shown and described in accordance with several preferred and practical embodiments thereof, it is recognized that departures from the instant disclosure are fully contemplated within the spirit and scope of the invention as defined in the following claims and as interpreted under the Doctrine of Equivalence.

What is claimed is:

1. A device for applying a prearranged pattern of decorative elements to a smooth surface of an object in a single application, said device comprising:
a coated bottom layer having an inner facing side;
a clear adhesive acetate top layer having an inner facing side;
a plurality of individual decorative elements sandwiched in between said inner facing side of said coated paper bottom layer and said inner facing side of said clear acetate top layer, said plurality of individual decorative elements being in a prearranged pattern, and said plurality of individual decorative elements each having a top side and a bottom side; and
an adhesive on said bottom side of said plurality of decorative elements.

2. The device for applying a prearranged pattern of decorative elements as recited in claim 1 wherein said plurality of decorative elements consists of a plurality of faceted plastic crystals.

3. The device for applying a prearranged pattern of decorative elements as recited in claim 1 wherein said plurality of decorative elements consists of a plurality of faceted glass crystals.

4. The device for applying a prearranged pattern of decorative elements as recited in claim 1 wherein said plurality of decorative elements consists of a plurality of rhinestones.

5. A method of applying a prearranged pattern of decorative elements in a single application, said method comprising the steps of:
providing a device for applying a prearranged pattern of decorative elements to a smooth surface of an object, said device comprising:
a coated bottom layer having an inner facing side;
a clear adhesive acetate top layer having an inner facing side;
a plurality of individual decorative elements sandwiched in between said inner facing side of said coated paper bottom layer and said inner facing side of said clear acetate top layer, said plurality of individual decorative elements being in a prearranged pattern, and said plurality of individual decorative elements each having a top side and a bottom side; and
an adhesive on said bottom side of said plurality of decorative elements;
removing said coated bottom layer while maintaining said coated bottom layer in a tight curl, thereby preventing said plurality of individual decorative elements from peeling off with said coated bottom layer;
applying the inner facing side of said clear adhesive acetate top layer to said smooth surface of said object, such that said prearranged pattern of decorative elements are in desired location, thereby adhering the inner facing side of said clear adhesive acetate top layer and said bottom side of said plurality of individual decorative elements to said smooth surface on said object;
removing said clear adhesive acetate top layer from said smooth surface of the object while maintaining said clear adhesive acetate top layer in a tight curl, thereby preventing said plurality of individual decorative elements from peeling off with said clear adhesive acetate top layer, and thereby leaving said prearranged pattern of decorative elements on said smooth surface of said object.
